(19) United States
(12) Patent Application Publication
(10) Pub. No.: US 2026/0320766 A1
(43) Pub. Date: Oct. 15, 2026

(54) METHOD FOR INSPECTION AND DEFECT IDENTIFICATION OF WATER SUPPLY PIPE NETWORK BASED ON IMAGE PROCESSING TECHNOLOGY

(71) Applicants: Innovation Center of Yangtze River Delta, ZJU, Jiaxing City (CN); Zhejiang University, Hangzhou City (CN); Tianjin Zhiyun Water Technology Co., Ltd., Tianjin (CN)

(72) Inventors: Jingqing LIU, Jiaxing City (CN); Weiping ZHANG, Jiaxing City (CN); Jiangxia WANG, Jiaxing City (CN); Xiujuan LI, Jiaxing City (CN); Xuesong WANG, Jiaxing City (CN); Qingzhou ZHANG, Jiaxing City (CN); Junfeng YU, Jiaxing City (CN)

(73) Assignees: Innovation Center of Yangtze River Delta, ZJU, Jiaxing City (CN); Zhejiang University, Hangzhou City (CN); Tianjin Zhiyun Water Technology Co., Ltd, Tianjin (CN)

(21) Appl. No.: 19/643,408

(22) Filed: Apr. 9, 2026

(30) Foreign Application Priority Data
Apr. 9, 2025 (CN) 202510435540.0

(51) Int. Cl. G06T 7/00; G06T 7/13; G06T 7/40; G06V 10/143; G06V 10/25; G06V 10/30; G06V 10/34; G06V 10/764; G06V 10/82

(52) U.S. Cl. CPC G06T 7/0002; G06T 7/13; G06T 7/40; G06V 10/143; G06V 10/25; G06V 10/30; G06V 10/34; G06V 10/764; G06V 10/82; G06T 2207/10048; G06T 2207/20036; G06T 2207/20084

(57) ABSTRACT

A method for inspection and defect identification of a water supply pipe network based on an image processing technology is provided. The method includes the following steps: S1, acquiring multi-band image data on a surface of a pipe network; S2, performing edge detection under geometric constraints on an enhanced image; S3, performing meshing division at equidistant detection units along an axial direction of a pipe; S4, performing multi-dimensional feature fusion extraction on each detection unit; S5, outputting a defect type and a quantitative parameter with confidence through a pre-trained defect classification model; and S6, generating a health state distribution map of the pipe network with spatial coordinate mapping according to a defect identification result of each detection unit.

### CROSS-REFERENCE TO RELATED PRESENT DISCLOSURE

This patent application claims the benefit and priority of Chinese Patent Application No. 202510435540.0 filed with the China National Intellectual Property Administration on Apr. 9, 2025, the disclosure of which is incorporated by reference herein in its entirety as part of the application.

### TECHNICAL FIELD

The present disclosure relates to the technical field of image processing and intelligent detection, and in particular to method for inspection and defect identification of a water supply pipe network based on an image processing technology.

### BACKGROUND

With the continuous acceleration of urbanization, a water supply pipe network, as a core component of urban infrastructures, plays a vital role in the normal operation of society in terms of operational safety and stability. Conventional inspection of the water supply pipe network mostly relies on manual inspection or simple device monitoring, and often has problems such as low inspection efficiency, a high missed inspection rate, and high maintenance costs. These problems not only affect timely maintenance of the pipe network, but also may lead to sudden failure of the pipe network, and even cause unpredictable consequences such as water pollution and pipe network paralysis in severe cases. In addition, defects, such as pipe corrosion, cracks, and deformation, are gradually accumulated in a long-term operation process, and early identification and accurate positioning of the defects have become a major problem in management of the pipe network.

Although continuous development of an image processing technology, a sensor technology, and artificial intelligence in recent years has improved the automation and intelligence level of inspection of the pipe network to a certain extent, the existing image processing technology still faces many challenges. In the prior art, inspection of the pipe network mostly relies on single image information. It is difficult to comprehensively take into account a plurality of factors such as pipe materials and illumination, resulting in poor image quality and lack of effective feature extraction and defect identification means. In addition, a conventional defect identification method is usually limited to a two-dimensional image, and fails to combine three-dimensional structural information of the pipe, resulting in failure to accurately quantify and efficiently display features such as spatial distribution, a depth, and a size of a defect.

### SUMMARY

Based on the foregoing objective, the present disclosure provides a method for inspection and defect identification of a water supply pipe network based on an image processing technology.

A method for inspection and defect identification of a water supply pipe network based on an image processing technology is provided, including the following steps:
S1, synchronously acquiring, by a multi-spectral imaging device, multi-band image data on a surface of a pipe network, and generating an enhanced image by using an adaptive illumination compensation algorithm integrating reflectivity characteristics of a material;
S2, performing edge detection under geometric constraints on the enhanced image, constructing a spatial filtering window based on a predetermined pipe diameter parameter, eliminating a reflection artifact by using an adaptive dual-threshold algorithm, and generating a mask image containing coordinates of a region of a pipe wall;
S3, extracting a Region of Interest (ROI) of the pipe wall based on the mask image, unfolding a curved surface of the pipe wall into a two-dimensional plane by using a curvature compensation algorithm for cylindrical projection, and performing meshing division at equidistant detection units along an axial direction of a pipe;
S4, performing multi-dimensional feature fusion extraction on each detection unit, to obtain a composite feature vector including a texture feature, near-infrared reflection intensity, and a geometric morphological feature;
S5, inputting the composite feature vector into a pre-trained defect classification model, and outputting a defect type and a quantitative parameter with confidence; and
S6, generating a health state distribution map of the pipe network with spatial coordinate mapping according to a defect identification result of each detection unit.

In some embodiments, S1 specifically includes:
S11, synchronously acquiring, by the multi-spectral imaging device, the multi-band image data on the surface of the pipe network, where the multi-spectral imaging device includes a plurality of band sensors configured to acquire image data of a visible light band, a near-infrared band, and a mid-infrared band, respectively;
S12, calculating a reflectivity difference of each band image according to spectral reflectivity characteristics of a pipe material in combination with reflectivity of each band of a multi-spectral image, and dynamically generating a compensation coefficient matrix based on reflectivity differences of the pipe material; and
S13, fusing a multi-band image by using the compensation coefficient matrix and using the adaptive illumination compensation algorithm, to optimize brightness and contrast of each band image to reduce influence of different illumination conditions on image quality.

In some embodiments, S2 specifically includes:
S21, performing the edge detection on the enhanced image, where an improved Canny edge detection algorithm is used for the edge detection, and a gradient of the enhanced image is analyzed by setting a high threshold and a low threshold to extract edge information of a pipe surface;
S22, constructing the spatial filtering window based on the predetermined pipe diameter parameter, where the spatial filtering window uses a circular structure to match an actual geometric shape of the pipe;
S23, eliminating the reflection artifact by using the adaptive dual-threshold algorithm, and adjusting thresholds according to reflection intensity of different regions, to optimize an edge detection result and eliminate false detection caused by reflection on the pipe surface; and
S24, generating the mask image containing the coordinates of the region of the pipe wall according to the edge detection result, where a region is formed through closing a detected edge of the region of the pipe wall by the mask image, and coordinate information of the region of the pipe is extracted.

In some embodiments, S23 specifically includes:
S231, separating a reflection region of an image by analyzing reflection intensity in the image, where assuming that the reflection intensity is I_{reflect}, a calculation formula is

$${I}_{reflect} = \frac{{I}_{max} - {I}_{min}}{{I}_{max} + {I}_{min}} ,$$

where Iₘₐₓ denotes the maximum light intensity value of each region of the image, Iₘᵢₙ denotes the minimum light intensity value of a corresponding region, and I_{reflect} denotes reflection intensity of the corresponding region;
S232, selecting different dual-threshold strategies for region classification according to the reflection intensity of the image, where specifically, the high threshold T_{high} and the low threshold T_{low} are set, and setting of the thresholds is dynamically adjusted according to the reflection intensity; and
S233, identifying a high reflection region and a low reflection region of the image through an adaptive dual-threshold strategy, and filtering a reflection artifact region of the image according to a threshold range of the reflection intensity, where specifically, the low reflection region is reserved as an effective pipe wall region, and the high reflection region is determined as the reflection artifact and then is removed.

In some embodiments, S3 specifically includes:
S31, unfolding the curved surface of the pipe wall into the two-dimensional plane by using the curvature compensation algorithm for the cylindrical projection, where specifically, a three-dimensional coordinate (x, y, z) of any point on a pipe surface is converted into a coordinate (u, v) on the two-dimensional plane by the following formula: u=r₁·θ, and v=z, where r₁ denotes a radius of the pipe, θ denotes an axial angle of a point of the pipe surface, and z denotes an axial height of a pipe point; and
S32, dividing detection units at an equal interval along the axial direction of the pipe according to an unfolded two-dimensional plane image, where the equal interval is calculated according to a total length of the pipe and the predetermined number of detection units, and a formula is

$$Δ z = \frac{L}{{n}_{1}} ,$$

where Δz denotes an axial length of each detection unit, L denotes the total length of the pipe, and n₁ denotes the number of detection units.

In some embodiments, S4 specifically includes:
S41, performing texture feature extraction on an image region of each detection unit, where the texture feature is calculated by a gray-level co-occurrence matrix, and statistics including energy, contrast, uniformity, and entropy are extracted;
S42, performing near-infrared reflection intensity feature extraction on the image region of each detection unit, where the reflection intensity is acquired by calculating an average reflection value of each detection unit in a near-infrared band;
S43, performing geometric morphological feature extraction on the image region of each detection unit, where the geometric morphological feature is a shape feature including an area, a perimeter and an aspect ratio; and
S44, fusing the texture feature extracted, a near-infrared reflection intensity feature and the geometric morphological feature into the composite feature vector, where the composite feature vector is obtained by weighted synthesis.

In some embodiments, S5 specifically includes:
S51, inputting the composite feature vector extracted into the pre-trained defect classification model, where the defect classification model is a convolutional neural network model based on deep learning, and the defect classification model improves feature extraction capability by embedding a channel attention mechanism;
S52, normalizing the composite feature vector to ensure that respective features have the same scale upon being inputted into the model, where by subtracting an average value of each dimension feature value in the composite feature vector from each dimension feature value of the composite feature vector, and dividing by a standard deviation, a normalized feature value is obtained;
S53, inputting the normalized composite feature vector into the pre-trained defect classification model, performing feature extraction and classification through a convolutional layer and a full connection layer, and finally outputting a confidence value of each potential defect; and
S54, outputting the defect type and the quantitative parameter with the confidence according to a classification result, where the defect type includes a crack, corrosion, and deformation, and the quantitative parameter includes a specific size, a depth, and a length of a defect.

In some embodiments, S51 specifically includes: S511, improving the feature extraction capability of the defect classification model by embedding the channel attention mechanism, where specifically, after each convolutional layer of a convolutional neural network, global information description of each channel is calculated by using a global average pooling operation, and a formula is

$${c}_{i} = \frac{1}{H \times W} {\sum }_{h = 1}^{H} {\sum }_{w = 1}^{W} {F}_{i , h , w} ,$$

where cᵢ denotes a global description value of an i-th channel, F_{i,h,w} denotes a feature value of the i-th channel at a position (h, w), and H and W denote a height and a width of a feature map, respectively;
S512, linearly transforming a global information description value, and generating a channel attention coefficient through the full connection layer, where a calculation formula is a=σ(W_{c}·c+b_{c}), where a denotes the channel attention coefficient, a denotes an activation function, We denotes a weight matrix of the full connection layer, be denotes a bias term, and c denotes a global description value; and
S513, performing a channel-wise multiplication operation on the channel attention coefficient and an original feature map to generate a weighted feature map, where the formula is \hat{F}ᵢ=aᵢ·Fᵢ, where \hat{F}ᵢ denotes a weighted feature map of the i-th channel, aᵢ denotes an attention coefficient of the i-th channel, and Fᵢ denotes an original feature map of the i-th channel.

In some embodiments, S53 specifically includes:
S531, inputting the normalized composite feature vector into the pre-trained defect classification model, where the defect classification model includes a plurality of convolutional layers and full connection layers, and the feature extraction is performed through the convolutional layers;
S532, after a plurality of convolution operations, reducing a dimension of the feature map through a pooling layer,
S533, inputting a pooled feature map to the full connection layer, and performing weighted summation on each feature through the weight matrix;
S534, after performing processing by the full connection layer, outputting a vector representing each potential defect type, where each element of the vector represents a confidence value of a specific defect type, a probability of each defect type is calculated by a Softmax activation function, a formula is

$${p}_{i} = \frac{{e}^{{y}_{i}}}{{\sum }_{{j}^{{e}^{{y}_{j}}}}} ,$$

where pᵢ denotes a probability of an i-th defect type, yᵢ denotes a predicted score of the i-th defect type, e^{y}^{ᵢ} denotes an exponential function of a score, and j denotes an index for all potential defect types, and yⱼ denotes a predicted score output by a j-th defect type, and the Softmax function converts scores of all types into probabilities, and a sum of probability values is 1, thereby outputting a confidence value for each defect type; and
S535, finally outputting a defect type with the highest confidence and a corresponding confidence value by ranking a confidence value of each potential defect type.

In some embodiments, S6 specifically includes:
S61, constructing a preliminary data model of a health state of the pipe network according to the defect identification result of each detection unit, where each detection unit corresponds to a three-dimensional spatial coordinate, indicating a specific position of the detection unit in the pipe;
S62, mapping the defect identification result of each detection unit to a corresponding three-dimensional spatial coordinate, and generating defect data points of each detection unit, where each data point contains the defect type, quantitative information of a size, a depth and a length of a defect, and spatial coordinate information of the data point in the pipe;
S63, performing spatial smoothing processing on the defect data by using a spatial interpolation method according to data points of all detection units, to obtain continuous distribution of the health state of the pipe network in space; and
S64, mapping data on the health state of the pipe network into a three-dimensional coordinate system by using a visualization technology based on the interpolated data, to generate the health state distribution map of the pipe network, where at the same time, severity of defects is visually displayed by using colors, specifically, red indicates a severe defect, green indicates no defects, and yellow indicates a minor defect.

The present disclosure has the following beneficial effects.

By combining a multi-spectral imaging technology and a deep learning model, the present disclosure achieves efficient inspection and defect identification of the water supply pipe network. Through synchronous acquisition of the multi-band image and an adaptive illumination compensation algorithm, image quality can be effectively improved, the influence of factors such as an illumination change and a material difference on image processing can be overcome, and accuracy of defect identification is ensured. At the same time, a multi-dimensional feature fusion extraction technology is used in combination with a texture feature, near-infrared reflection intensity, and a geometric morphological feature, thereby significantly improving an identification rate of pipe defects.

The present disclosure breaks through the limitation of conventional two-dimensional image analysis by constructing a health state distribution map of the pipe network with spatial coordinate mapping, and achieves three-dimensional visual display of the health state of the pipe network. Combined with a spatial interpolation technology, the present disclosure fills a detection blind area, and optimizes the health state distribution map, so that spatial distribution, severity, and position of defects are displayed more intuitively and accurately.

### BRIEF DESCRIPTION OF THE DRAWINGS

In order to explain the technical solution of the present disclosure or the prior art more clearly, the drawings needed to be used in the description of the embodiment or the prior art will be briefly introduced below. Obviously, the drawings in the following description are only some embodiments of the present disclosure. Other drawings can be obtained according to these drawings without paying creative labor for those skilled in the art.

FIG. 1 is a schematic diagram of a method for inspection and defect identification of a water supply pipe network according to an embodiment of the present disclosure.

FIG. 2 is a schematic diagram of a method for generating a health state distribution map of a pipe network according to an embodiment of the present disclosure.

### DETAILED DESCRIPTION OF THE EMBODIMENTS

The present disclosure will be described in detail with reference to the drawings and specific embodiments. At the same time, it is explained here that in order to make the embodiments more detailed, the following embodiments are the optimal and preferred embodiments, and those skilled in the art can also use other alternative manner to implement some known technologies. Moreover, the drawings are only used for describing the embodiment more specifically, and are not intended to limit the present disclosure specifically.

It should be pointed out that references to “one embodiment”, “an embodiment”, “exemplary embodiment”, and “some embodiments” in the specification indicate that the described embodiments may include specific features, structures or characteristics, but not every embodiment necessarily includes the specific features, structures or characteristics. In addition, when describing the specific features, structures or characteristics in combination with an embodiment, it should be within the knowledge of those skilled in the art to achieve such features, structures or characteristics in combination with other embodiments (whether explicitly described).

Generally, terms can be understood at least in part from the use in the context. For example, depending at least in part on the context, a term “one or more” as used herein can be used to describe any feature, structure or characteristic in a singular sense, or can be used to describe a combination of features, structures or characteristic in a plural sense. In addition, a term “based on” can be understood as not necessarily intended to convey a set of exclusive factors, but may alternatively, at least partially depend on the context, allowing presence of other factors that are not necessarily explicitly described.

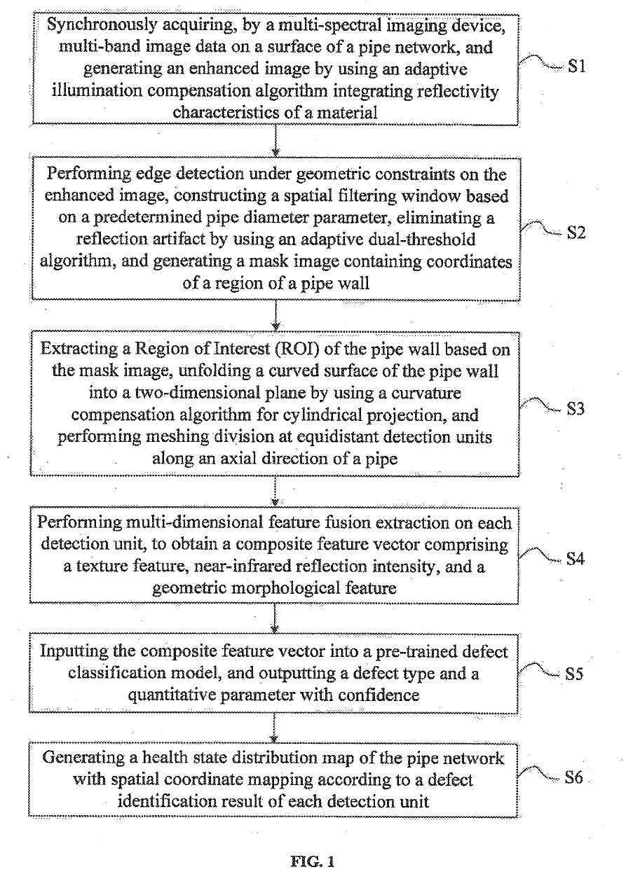

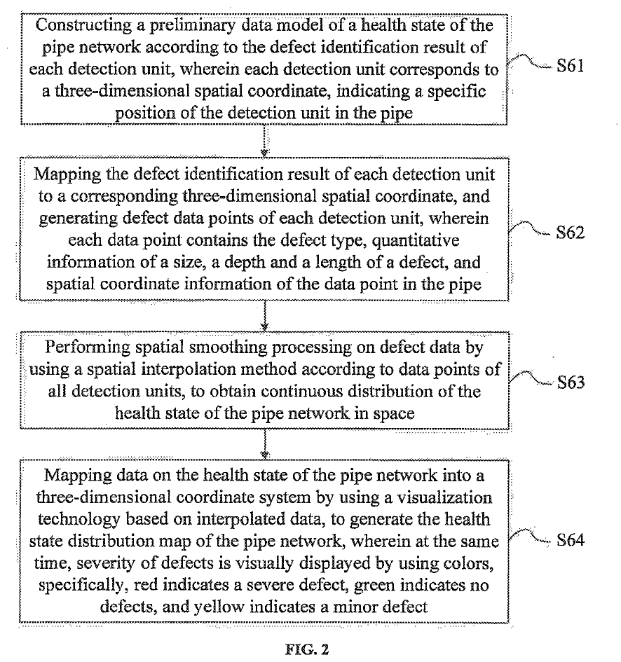

As shown in FIG. 1 and FIG. 2, a method for inspection and defect identification of a water supply pipe network based on an image processing technology is provided, including the following steps.

In step S1, the multi-band image data on a surface of a pipe network is synchronously acquired by a multi-spectral imaging device, and an enhanced image is generated by using an adaptive illumination compensation algorithm integrating reflectivity characteristics of a material.

In step S2, the edge detection under geometric constraints is performed on the enhanced image, a spatial filtering window is constructed based on a predetermined pipe diameter parameter, a reflection artifact is eliminated by using an adaptive dual-threshold algorithm, and a mask image containing coordinates of a pipe wall region is generated.

In step S3, a Region of Interest (ROI) of the pipe wall is extracted based on the mask image, a curved surface of the pipe wall is unfolded into a two-dimensional plane by using a curvature compensation algorithm for cylindrical projection, and the meshing division is performed at equidistant detection units along an axial direction of a pipe.

In step S4, the multi-dimensional feature fusion extraction is performed on each detection unit, to obtain a composite feature vector including a texture feature, near-infrared reflection intensity, and a geometric morphological feature.

In step S5, the composite feature vector is inputted into a pre-trained defect classification model, and a defect type and a quantitative parameter with confidence are outputted. The defect classification model improves feature extraction capability by embedding a channel attention mechanism.

In step S6, a health state distribution map of the pipe network with spatial coordinate mapping is generated according to a defect identification result of each detection unit.

S1 specifically includes as follow.

In step S11, the multi-band image data on the surface of the pipe network is synchronously acquired by the multi-spectral imaging device. The multi-spectral imaging device includes a plurality of band sensors configured to acquire image data of a visible light band, a near-infrared band, and a mid-infrared band, respectively. An acquisition frequency and a resolution of each band sensor are matched to ensure synchronous acquisition of data in different bands and consistency of image quality.

In step S12, a reflectivity difference of each band image is calculated according to the spectral reflectivity characteristics of a pipe material in combination with reflectivity of each band of the multi-spectral image, and a compensation coefficient matrix is dynamically generated based on the reflectivity differences of the pipe material. The calculation formula of the reflectivity difference is ΔR_{b}=R_{b}−R_{b,ref}, where ΔR_{b} denotes the reflectivity difference of the image in the b-th band, R_{b} denotes actual reflectivity of the b-th band, and R_{b,ref} denotes reflectivity of a reference band. A compensation coefficient matrix C is generated by calculating the reflectivity differences of all bands, in which an element of the compensation coefficient matrix is an adjustment coefficient of each band to reflect illumination compensation requirements of different bands. For each band b, a compensation coefficient C_{b} thereof calculated by the following formula:

$${C}_{b} = \frac{{Δ R}_{b}}{{\sum }_{b = 1}^{n} {Δ R}_{b}} ,$$

where n denotes the total number of bands.

In step S13, the multi-band image is fused by using the compensation coefficient matrix and using the adaptive illumination compensation algorithm, to optimize brightness and contrast of each band image to reduce the influence of different illumination conditions on image quality. The adaptive illumination compensation formula is:

$${I}_{b}^{′} = ( {I}_{b} - min ( {I}_{b} ) ) \times \frac{{C}_{b}}{max ( {I}_{b} ) - min ( {I}_{b} )} + min ( {I}_{b} ) ,$$

where I_{b} denotes original image intensity of the b-th band, C_{b} denotes a compensation coefficient of the b-th band, I_{b}′ denotes compensated image intensity, and min(I_{b}) and max(I_{b}) denote the minimum value and the maximum value of the image in the b-th band, respectively. Through the above formula, the brightness and contrast of the image in each band are adjusted, so that the overall illumination of the image is balanced, and the influence of different illumination conditions on the image quality is reduced.

In the above steps, the multi-band image data on the surface of the pipe network is synchronously acquired through the multi-spectral imaging device, a compensation coefficient matrix is generated in combination with the reflectivity difference of the material, and an adaptive illumination compensation algorithm is implemented, thereby significantly improving the image quality under different illumination conditions. The technology can eliminate image distortion caused by uneven illumination, thereby ensuring subsequent defect identification accuracy.

S2 specifically includes as follow.

In step S21, the edge detection is performed on the enhanced image. An improved Canny edge detection algorithm is used for edge detection. A gradient of the enhanced image is analyzed by setting a high threshold and a low threshold to extract edge information of a pipe surface.

In step S22, the spatial filtering window is constructed based on the predetermined pipe diameter parameter. The spatial filtering window uses a circular structure to match an actual geometric shape of the pipe. The spatial filtering window is used to further smooth the image and filter noise to ensure accuracy of edge extraction. It is assumed that a radius of the spatial filtering window is r, and the calculation formula is:

$$r = \frac{d}{2} ,$$

where d denotes the predetermined pipe diameter parameter, and r denotes the radius of the filtering window. This formula ensures that a size of the filtering window is consistent with an actual size of the pipe, thereby better matching the geometric shape of the pipe.

In step S23, the reflection artifact is eliminated by using an adaptive dual-threshold algorithm, and the thresholds are adjusted according to reflection intensity of different regions, to optimize an edge detection result and eliminate false detection caused by reflection on the pipe surface.

In step S24, the mask image containing the coordinates of a pipe wall region is generated according to the edge detection result. The mask image refers to a region formed through closing a detected edge of the pipe wall region, and the coordinate information of the region of the pipe is extracted, thereby providing an accurate Region of Interest (ROI) for subsequent processing. In the above steps, the surface edge information of the pipe can be effectively extracted through the improved Canny edge detection algorithm, and the high threshold and the low threshold are dynamically adjusted, so that edge detection can adapt to features of different images, and accuracy of edge extraction is improved. The introduction of the spatial filtering window further ensures smoothness and accuracy of edge extraction, while the application of the adaptive dual-threshold algorithm effectively eliminates the influence of reflection artifacts on image quality. The final generated mask image provides an accurate coordinate of the pipe wall region for subsequent pipe defect identification.

S23 specifically includes as follow.

In step S231, a reflection region of an image is separated by analyzing reflection intensity in the image. Assuming that the reflection intensity is I_{reflect}, a calculation formula is:

$${I}_{reflect} = \frac{{I}_{max} - {I}_{min}}{{I}_{max} + {I}_{min}} ,$$

where Iₘₐₓ denotes the maximum light intensity value of each region of the image, Iₘᵢₙ denotes the minimum light intensity value of a corresponding region, and I_{reflect} denotes reflection intensity of the corresponding region.

In step S232, the different dual-threshold strategies are selected for region classification according to the reflection intensity of the image. Specifically, a high threshold T_{high} and a low threshold T_{low} are set, and setting of the thresholds is dynamically adjusted according to the reflection intensity. The calculation formulas of the high threshold T_{high} and the low threshold T_{low} are: T_{high}=μ+k₁·σ; and T_{low}=μ−k₂·σ, where μ denotes an average value of image reflection intensity, a denotes a standard deviation of reflection intensity, and k₁ and k₂ denote adjustment coefficients, which are used to flexibly adjust the range of the high threshold and the low threshold to adapt to reflection intensity features of different regions.

In step S233, a high reflection region and a low reflection region of the image are identified through an adaptive dual-threshold strategy, and a reflection artifact region of the image is filtered according to a threshold range of reflection intensity. Specifically, the low reflection region is reserved as an effective pipe wall region, and the high reflection region is determined as a reflection artifact and then is removed. In the above steps, the thresholds can be dynamically adjusted according to the reflection intensity of different regions through the adaptive dual-threshold algorithm, and the reflection artifact in the image can be accurately identified and eliminated. This method can effectively distinguish an effective region of the pipe surface from a reflection artifact region caused by illumination, thereby ensuring that an edge extraction process is not disturbed by the artifact, and improving accuracy of pipe defect detection.

S3 specifically includes as follow.

In step S31, the curved surface of the pipe wall is unfolded into the two-dimensional plane by using the curvature compensation algorithm for cylindrical projection. The cylindrical projection algorithm performs calculation according to a radius and an axial angle of the pipe, to obtain the two-dimensional coordinate position of each point on the pipe wall. Specifically, a three-dimensional coordinate (x, y, z) of any point on the pipe surface is converted into a coordinate (u, v) on the two-dimensional plane by the following formula: u=r₁·θ; and v=z, where r₁ denotes a radius of the pipe, θ denotes an axial angle of a point of the pipe surface, and z denotes an axial height of a pipe point. This formula unfolds the pipe surface into a two-dimensional plane, thereby avoiding a deformation error caused by the curvature of the pipe.

In step S32, the detection units are divided at an equal interval along an axial direction of the pipe according to an unfolded two-dimensional plane image. The equal interval is calculated according to a total length of the pipe and the predetermined number of detection units, and the formula is:

$$Δ z = \frac{L}{{n}_{1}} ,$$

where Δz denotes an axial length of each detection unit, L denotes a total length of the pipe, and n₁ denotes the number of detection units. Through this formula, the pipe is evenly divided into several detection units along the axial direction, ensuring that each unit may be detected accurately. The divided two-dimensional region of each detection unit is used as a basic unit of analysis, and further processing is performed according to the texture feature, the reflection intensity and the geometric morphological feature of each unit, thereby providing efficient region division and accurate data support for defect identification.

S4 specifically includes as follow.

In step S41, the texture feature extraction is performed on an image region of each detection unit. The texture feature is calculated by a Gray-Level Co-Occurrence Matrix (GLCM), statistics including energy, contrast, uniformity, and entropy are extracted, and the formula is as follows: energy=Σ_{i,j}p(i,j); contrast=Σ_{i,j}(i−j)²p(i,j);

$$uniformity = {\sum }_{i , j} \frac{p ( i , j )}{1 + {( í - j )}^{2}} ;$$

and entropy=−Σ_{i,j}p(i,j)log(p(i,j)), where p(i,j) denotes an element of the gray-level co-occurrence matrix, i and j denote gray-level values of different pixels in the image, and the statistics are used to describe a texture distribution feature of the image region.

In step S42, the near-infrared reflection intensity feature extraction is performed on the image region of each detection unit. The reflection intensity is acquired by calculating an average reflection value of each detection unit in the near-infrared band, and the calculation formula is:

$${I}_{NIR} = \frac{1}{n} {\sum }_{i = 1}^{{n}_{2}} {I}_{NIR , i} ,$$

where I_{NIR,i} denotes a reflection intensity value of the near-infrared band in the i-th detection unit, n₂ denotes the number of pixel points in the detection unit, and I_{NIR} denotes average reflection intensity of the region; and the feature is used to capture the illumination feature of the pipe surface and help to distinguish the pipe surfaces with different materials or damage degrees.

In step S43, the geometric morphological feature extraction is performed on the image region of each detection unit. The geometric morphological feature is a shape feature including an area, a perimeter and an aspect ratio, and the specific calculation formula is: Area=Σ_{i,j}p(i,j); Perimeter=Σ_{i,j}\sqrt{(xᵢ₊₁−xᵢ)²+(yᵢ₊₁−yᵢ)²}; and

$$AspectRatio = \frac{Major AxisLength}{Minor AxisLength} ;$$

where (xᵢ,yᵢ) denotes a coordinate of the i-th point in the image, Area denotes an area of the detection unit, Perimeter denotes a boundary length of the corresponding region, AspectRatio denotes an aspect ratio of the region, MajorAxisLength denotes a length of a major axis in the optimal ellipse of a fitting region, representing the maximum size of the region; and MinorAxisLength denotes a length of a minor axis in the optimal ellipse of the fitting region, representing the minimum size of the region; and these features are used to describe geometric information of the detection unit and help to further determine whether there are defects on the pipe surface.

In step S44, the extracted texture feature, the near-infrared reflection intensity feature, and the geometric morphological feature are fused into a composite feature vector. The composite feature vector is obtained by weighted synthesis, and the calculation formula is: F_{composite}=w₁·Fₜₑₓₜᵤᵣₑ+w₂·F_{NIR}+w₃·F_{geometry}, where F_{composite} denotes a composite feature vector, Fₜₑₓₜᵤᵣₑ, denotes a texture feature vector, F_{NIR} denotes a near-infrared reflection intensity feature vector, and F_{geometry} denotes a geometric morphological feature vector, and w₁, w₂, and w₃ denote weighting coefficients of respective features, and the weighting coefficients are set according to the contribution of the respective features to defect identification. In the above steps, by performing the multi-dimensional feature fusion on each detection unit, a texture feature, a near-infrared reflection intensity feature and a geometric morphological feature can be fully utilized to comprehensively analyze the pipe surface from a plurality of angles. The weighted fusion of each feature not only enhances defect identification capability, but also improves sensitivity to different materials and damage degrees.

S5 specifically includes as follow.

In step S51, the extracted composite feature vector is inputted into the pre-trained defect classification model. The defect classification model is a Convolutional Neural Network (CNN) Model based on deep learning, and the defect classification model improves feature extraction capability by embedding a channel attention mechanism. The defect classification model has been trained on a large number of labeled data, and can identify a plurality of types of pipe defects and map the composite feature to a corresponding defect type.

In step S52, the composite feature vector is normalized to ensure that respective features have the same scale upon being inputted into the model. By subtracting, from each dimension feature value of the composite feature vector, an average value of the dimension feature value, and dividing by a standard deviation of the dimension feature value, a normalized feature value is obtained. The normalized composite feature vector can improve the stability and convergence speed of model training.

In step S53, the normalized composite feature vector is inputted into the pre-trained defect classification model, the feature extraction and classification are performed through a convolutional layer and a full connection layer, and finally a confidence value of each potential defect is outputted. The confidence value represents the prediction confidence of the model for a specific defect type, usually ranging from 0 to 1.

In step S54, a defect type and a quantitative parameter with confidence are outputted according to a classification result. The defect type includes a crack, corrosion and deformation, and the quantitative parameter includes a specific size, a depth and a length of the defect. The output result provides accurate data support for the subsequent analysis of the health state of the pipe network. In the above steps, the composite feature vector is input into the pre-trained defect classification model, which can efficiently classify and quantitatively analyze the pipe defects. Normalization ensures that the contribution of different features to the model input are relatively balanced, thereby improving stability and prediction accuracy of the model. The output result with confidence not only provides the defect types, but also provides a quantitative parameter for the severity and influence range of defects, so that inspection of the pipe network is more accurate and efficient.

S51 specifically includes as follow.

In step S511, the feature extraction capability of the defect classification model is improved by embedding the Channel Attention Mechanism (CAM). The channel attention mechanism is used to dynamically adjust the weight of each feature channel to enhance the attention to key features. Specifically, after each convolutional layer of the convolutional neural network, global information description of each channel is calculated by using a Global Average Pooling (GAP) operation, and the formula is:

$${c}_{i} = \frac{1}{H \times W} {\sum }_{h = 1}^{H} {\sum }_{w = 1}^{W} {F}_{i , h , w} ,$$

where cᵢ denotes a global description value of an i-th channel, F_{i,h,w} denotes a feature value of the i-th channel at a position (h, w), and H and W denote a height and a width of the feature map, respectively. In this step, the global average pooling is performed on each channel to extract the global information feature of the channel.

In step S512, the global information description value is linearly transformed, and a channel attention coefficient is generated through the full connection layer. The calculation formula is: a=σ(W_{c}−c+b_{c}), where a denotes a channel attention coefficient, σ denotes an activation function (usually using the Sigmoid function), We denotes a weight matrix of the full connection layer, b_{c} denotes a bias term, and c denotes a global description value. In the operation, the global information is converted into the weight coefficient of each channel for controlling the attention of each channel.

In step S513, a channel-wise multiplication operation is performed on the channel attention coefficient and an original feature map to generate a weighted feature map. The formula is: \hat{F}ᵢ=aᵢ·Fᵢ, where \hat{F}ᵢ denotes a weighted feature map of the i-th channel, aᵢ denotes an attention coefficient of the i-th channel, and Fᵢ denotes an original feature map of the i-th channel. In the operation, the attention of the network to important features is enhanced by adjusting the weight of each channel. Finally, subsequent convolution operation and full connection layer processing are performed through a weighted feature map of a channel attention mechanism to optimize a feature extraction process and improve identification capability of the defect classification model for different defect types. In the above steps, the weight of each channel can be dynamically adjusted by embedding the channel attention mechanism, thereby enhancing the capability of extracting key features.

S53 specifically includes as follow.

In step S531, the normalized composite feature vector is inputted into the pre-trained defect classification model. The defect classification model includes a plurality of convolutional layers and full connection layers, and feature extraction is performed through the convolutional layers. Specifically, each convolutional layer uses a set of convolution kernels (filters) to perform convolution operation on the input feature, and the convolution formula is: Fₒᵤₜ(i,j)=Σ_{m,n}Fᵢₙ(i+m,j+n)·K(m,n), where Fₒᵤₜ(i,j) denotes a value of the output feature map at the (i,j)-th position, Fᵢₙ(i+m, j+n) denotes a value of the corresponding region in the input feature map, and K(m,n) denotes the (m, n)-th value of the convolution kernel. In this way, the convolutional layer extracts local feature information in the feature map.

In step S532, after a plurality of convolutional operations, a dimension of the feature map is reduced through a pooling layer (such as maximum pooling or average pooling). The calculation formula of the maximum pooling operation is: P(i,j)=max(Fₒᵤₜ(i,j), Fₒᵤₜ(i+1,j), Fₒᵤₜ(i, j+1), Fₒᵤₜ(i+1, j+1)), where P(i,j) denotes a pooled feature value, and the pooling operation helps to keep main information in the feature and reduce a calculation amount at the same time.

In step S533, a pooled feature map is inputted to the full connection layer for the high-level feature combination and classification operation. The full connection layer performs weighted summation on each feature through the weight matrix, the formula is: y=W·x+b, where x denotes a pooled feature vector, W denotes a weight matrix of the full connection layer, b denotes a bias term, and y denotes output of the full connection layer. The function of the full connection layer is to map a low-level feature to a high-level representation and make classification decisions.

In step S534, after performing processing by the full connection layer, a vector representing each potential defect type is outputted. Each element of the vector represents a confidence value of a specific defect type, the probability of each defect type is calculated by a Softmax activation function, and the formula is:

$${p}_{i} = \frac{{e}^{{y}_{i}}}{{\sum }_{{j}^{{e}^{{y}_{j}}}}} ,$$

where pᵢ denotes the probability of an i-th defect type, yᵢ denotes a predicted score of the i-th defect type, e^{y}^{ᵢ} denotes an exponential function of the score, and j denotes an index for all potential defect types, and yⱼ denotes a predicted score output by a j-th defect type, and the Softmax function converts scores of all types into probabilities, and a sum of probability values is 1, thereby outputting a confidence value for each defect type.

In step S535, finally the defect type with the highest confidence and the corresponding confidence value are outputted by ranking confidence values of each potential defect type. Through multi-level processing of the convolutional layer and the full connection layer, in the above steps, the defect classification model can extract multi-level features from a low level to a high level, thereby further enhancing identification capability of the model. The convolution operation effectively captures a local feature of the image, and the pooling operation helps to reduce unnecessary calculation and improve robustness of the feature representation. Through the confidence value output by the Softmax function, the model can give confidence of the defect type in a probability form, thereby providing more accurate and credible classification results.

S6 specifically includes as follow.

In step S61, a preliminary data model of the health state of the pipe network is constructed according to the defect identification result of each detection unit. Each detection unit corresponds to a three-dimensional spatial coordinate, indicating a specific position of the detection unit in the pipe.

In step S62, the defect identification result of each detection unit is mapped to the corresponding three-dimensional spatial coordinate, and defect data points of each detection unit are generated. Each data point contains the defect type (such as a crack, corrosion or deformation), quantitative information of a size, a depth and a length of the defect, and spatial coordinate information of the data point in the pipe.

In step S63, the spatial smoothing processing is performed on the defect data by using a spatial interpolation method according to data points of all detection units, to obtain continuous distribution of the health state of the pipe network in space. Specifically, a three-dimensional Gaussian smoothing algorithm or an interpolation algorithm, such as a nearest neighbor interpolation and a bilinear interpolation, can be used to fill in the missing data of the undetected region, so as to smooth and optimize a health state distribution map.

In step S64, the data on the health state of the pipe network is mapped into a three-dimensional coordinate system by using a visualization technology based on the interpolated data, to generate a health state distribution map of the pipe network for displaying the defect distribution at various positions within the pipe and labeling the type, position, and severity of defects. At the same time, severity of defects is visually displayed by using colors. Specifically, red indicates a severe defect, a green indicates no defects, and yellow indicates a minor defect. In the above steps, the health state distribution map of the pipe network generated by the spatial coordinate mapping can visually display the defects of each position in the pipe network. In combination with the spatial interpolation technology, the undetectable regions can be supplemented and optimized, thereby improving the comprehensiveness and accuracy of analysis of the health state of the pipe network. The distribution map can provide intuitive and accurate data support for maintenance and repair of the pipe network, so that managers can make scientific and reasonable decisions quickly based on a graphical result, thereby improving inspection efficiency of the pipe network.

The present disclosure covers any substitution, modification, equivalent methods, and solutions within the spirit and the scope of the present disclosure. In order to make the public have a thorough understanding of the present disclosure, specific details are described in the following preferred embodiments of the present disclosure, and those skilled in the art can fully understand the present disclosure without the description of these details. In addition, in order to avoid unnecessarily confusing the essence of the present disclosure, well-known methods, procedures, flows, components, and circuits have not been described in detail.

The above is only the preferred embodiment of the present disclosure. It should be pointed out that those skilled in the art can make several improvements and modifications without departing from the principle of the present disclosure. These improvements and modifications should also be regarded as the scope of protection of the present disclosure.

1. A method for Inspection and defect identification of a water supply pipe network based on an image processing technology, comprising the following steps:
S1, synchronously acquiring, by a multi-spectral Imaging device, multi-band Image data on a surface of a pipe network, and generating an enhanced image by using an adaptive illumination compensation algorithm integrating reflectivity characteristics of a material;
S2, performing edge detection under geometric constraints on the enhanced Image, constructing a spatial filtering window based on a predetermined pipe diameter parameter, eliminating a reflection artifact by using an adaptive dual-threshold algorithm, and generating a mask image containing coordinates of a region of a pipe wall;
S3, extracting a Region of Interest (ROI) of the pipe wall based on the mask Image, unfolding a curved surface of the pipe wall into a two-dimensional plane by using a curvature compensation algorithm for cylindrical projection, and performing meshing division at equidistant detection units along an axial direction of a pipe;
S4, performing multi-dimensional feature fusion extraction on each detection unit, to obtain a composite feature vector comprising a texture feature, near-infrared reflection intensity, and a geometric morphological feature;
S5, inputting the composite feature vector into a pre-trained defect classification model, and outputting a defect type and a quantitative parameter with confidence; and
S6, generating a health state distribution map of the pipe network with spatial coordinate mapping according to a defect Identification result of each detection unit.

2. The method for inspection and defect Identification of the water supply pipe network based on the image processing technology according to claim 1, wherein S1 specifically comprises:
S11, synchronously acquiring, by the multi-spectral Imaging device, the multi-band image data on the surface of the pipe network, wherein the multi-spectral Imaging device comprises a plurality of band sensors configured to acquire image data of a visible light band, a near-infrared band, and a mid-infrared band, respectively;
S12, calculating a reflectivity difference of each band Image according to spectral reflectivity characteristics of a pipe material in combination with reflectivity of each band of a multi-spectral image, and dynamically generating a compensation coefficient matrix based on reflectivity differences of the pipe material; and
S13, fusing a multi-band image by using the compensation coefficient matrix and using the adaptive Illumination compensation algorithm, to optimize brightness and contrast of each band image to reduce Influence of different illumination conditions on image quality.

3. The method for inspection and defect Identification of the water supply pipe network based on the image processing technology according to claim 1, wherein S2 specifically comprises:
S21, performing the edge detection on the enhanced image, wherein an improved Canny edge detection algorithm is used for the edge detection, and a gradient of the enhanced image is analyzed by setting a high threshold and a low threshold to extract edge information of a pipe surface;
S22, constructing the spatial filtering window based on the predetermined pipe diameter parameter, wherein the spatial filtering window uses a circular structure to match an actual geometric shape of the pipe;
S23, eliminating the reflection artifact by using the adaptive dual-threshold algorithm, and adjusting thresholds according to reflection intensity of different regions, to optimize an edge detection result and eliminate false detection caused by reflection on the pipe surface; and
S24, generating the mask image containing the coordinates of the region of the pipe wall according to the edge detection result, wherein the mask image refers to a region formed through closing a detected edge of the region of the pipe wall, and coordinate information of the region of the pipe is extracted.

4. The method for inspection and defect identification of the water supply pipe network based on the image processing technology according to claim 3, wherein S23 specifically comprises:
S231, separating a reflection region of an image by analyzing reflection intensity in the image, wherein assuming that the reflection intensity is I_{reflect}, a calculation formula is
$${I}_{reflect} = \frac{{I}_{max} - {I}_{min}}{{I}_{max} + {I}_{min}} ,$$
where Iₘₐₓ denotes a maximum light intensity value of each region of the image, Iₘᵢₙ denotes a minimum light intensity value of a corresponding region, and I_{reflect} denotes reflection intensity of the corresponding region;
S232, selecting different dual-threshold strategies for region classification according to the reflection intensity of the image, wherein specifically, the high threshold T_{high} and the low threshold T_{low} are set, and setting of the thresholds is dynamically adjusted according to the reflection intensity; and
S233, Identifying a high reflection region and a low reflection region of the image through an adaptive dual-threshold strategy, and filtering a reflection artifact region of the image according to a threshold range of the reflection intensity, wherein specifically, the low reflection region is reserved as an effective pipe wall region, and the high reflection region is determined as the reflection artifact and then is removed.

5. The method for inspection and defect identification of the water supply pipe network based on the image processing technology according to claim 1, wherein S3 specifically comprises:
S31, unfolding the curved surface of the pipe wall into the two-dimensional plane by using the curvature compensation algorithm for the cylindrical projection, wherein specifically, a three-dimensional coordinate (x, y, z) of any point on a pipe surface is converted into a coordinate (u, v) on the two-dimensional plane by the following formula: u=r₁·θ, and v=z, where r₁ denotes a radius of the pipe, θ denotes an axial angle of a point of the pipe surface, and z denotes an axial height of a pipe point; and
S32, dividing detection units at an equal interval along the axial direction of the pipe according to an unfolded two-dimensional plane image, wherein the equal interval is calculated according to a total length of the pipe and a predetermined number of detection units, and a formula is
$$Δ z = \frac{L}{{n}_{1}} ,$$
where Δz denotes an axial length of each detection unit, L denotes the total length of the pipe, and n₁ denotes a number of detection units.

6. The method for inspection and defect Identification of the water supply pipe network based on the image processing technology according to claim 1, wherein S4 specifically comprises:
S41, performing texture feature extraction on an Image region of each detection unit, wherein the texture feature is calculated by a gray-level co-occurrence matrix, and statistics comprising energy, contrast, uniformity, and entropy are extracted;
S42, performing near-infrared reflection Intensity feature extraction on the image region of each detection unit, wherein the reflection intensity is acquired by calculating an average reflection value of each detection unit in a near-infrared band;
S43, performing geometric morphological feature extraction on the image region of each detection unit, wherein the geometric morphological feature is a shape feature comprising an area, a perimeter and an aspect ratio; and
S44, fusing the texture feature extracted, a near-infrared reflection intensity feature and the geometric morphological feature into the composite feature vector, wherein the composite feature vector is obtained by weighted synthesis.

7. The method for inspection and defect identification of the water supply pipe network based on the image processing technology according to claim 1, wherein S5 specifically comprises:
S51, inputting the composite feature vector extracted into the pre-trained defect classification model, wherein the defect classification model is a convolutional neural network model based on deep learning, and the defect classification model improves feature extraction capability by embedding a channel attention mechanism;
S52, normalizing the composite feature vector to ensure that respective features have a same scale upon being inputted into the model, wherein by subtracting, from each dimension feature value of the composite feature vector, an average value of the dimension feature value, and dividing by a standard deviation, a normalized feature value is obtained;
S53: inputting the normalized composite feature vector into the pre-trained defect classification model, performing feature extraction and classification through a convolutional layer and a full connection layer, and finally outputting a confidence value of each potential defect; and
S54, outputting the defect type and the quantitative parameter with the confidence according to a classification result, wherein the defect type comprises a crack, corrosion, and deformation, and the quantitative parameter comprises a specific size, a depth, and a length of a defect.

8. The method for inspection and defect Identification of the water supply pipe network based on the image processing technology according to claim 7, wherein S51 specifically comprises:
S511, improving the feature extraction capability of the defect classification model by embedding the channel attention mechanism, wherein specifically, after each convolutional layer of a convolutional neural network, global information description of each channel is calculated by using a global average pooling operation, and a formula is
$${c}_{i} = \frac{1}{H \times W} {\sum }_{h = 1}^{H} {\sum }_{w = 1}^{W} {F}_{i , h , w} ,$$
where cᵢ denotes a global description value of an P-th channel, F_{i,h,w} denotes a feature value of the i-th channel at a position (h, w), and H and W denote a height and a width of a feature map, respectively;
S512, linearly transforming a global information description value, and generating a channel attention coefficient through the full connection layer, wherein a calculation formula is a=σ(W_{c}·c+b_{c}), where a denotes the channel attention coefficient, σ denotes an activation function, W_{c} denotes a weight matrix of the full connection layer, b_{c} denotes a bias term, and c denotes a global description value; and
S513, performing a channel-wise multiplication operation on the channel attention coefficient and an original feature map to generate a weighted feature map, wherein a formula is \hat{F}ᵢ=aᵢ·Fᵢ, where \hat{F}ᵢ denotes a weighted feature map of the i-th channel, aᵢ denotes an attention coefficient of the P-th channel, and Fᵢ denotes an original feature map of the i-th channel.

9. The method for inspection and defect identification of the water supply pipe network based on the image processing technology according to claim 8, wherein S53 specifically comprises:
S531, inputting the normalized composite feature vector into the pre-trained defect classification model, wherein the defect classification model comprises a plurality of convolutional layers and full connection layers, and the feature extraction is performed through the convolutional layers;
S532, after a plurality of convolution operations, reducing a dimension of the feature map through a pooling layer;
S533, Inputting a pooled feature map to the full connection layer, and performing weighted summation on each feature through the weight matrix;
S534, after performing processing by the full connection layer, outputting a vector representing each potential defect type, wherein each element of the vector represents a confidence value of a specific defect type, a probability of each defect type is calculated by a Softmax activation function, a formula is
$${p}_{i} = \frac{{e}^{{y}_{i}}}{{\sum }_{{j}^{{e}^{{y}_{j}}}}} ,$$
where pᵢ denotes a probability of an i-th defect type, yᵢ denotes a predicted score of the i-th defect type, e^{y}^{ᵢ}, denotes an exponential function of a score, and j denotes an index for all potential defect types, and yⱼ denotes a predicted score output by a j-th defect type, and the Softmax function converts scores of all types into probabilities, and a sum of probability values is 1, thereby outputting a confidence value for each defect type; and
S535, finally outputting a defect type with a highest confidence and a corresponding confidence value by ranking a confidence value of each potential defect type.

10. The method for inspection and defect identification of the water supply pipe network based on the image processing technology according to claim 1, wherein S6 specifically comprises:
S61, constructing a preliminary data model of a health state of the pipe network according to the defect identification result of each detection unit, wherein each detection unit corresponds to a three-dimensional spatial coordinate, Indicating a specific position of the detection unit in the pipe;
S62, mapping the defect identification result of each detection unit to a corresponding three-dimensional spatial coordinate, and generating defect data points of each detection unit, wherein each data point contains the defect type, quantitative information of a size, a depth and a length of a defect, and spatial coordinate information of the data point in the pipe;
S63, performing spatial smoothing processing on defect data by using a spatial Interpolation method according to data points of all detection units, to obtain continuous distribution of the health state of the pipe network in space; and
S64, mapping data on the health state of the pipe network into a three-dimensional coordinate system by using a visualization technology based on interpolated data, to generate the health state distribution map of the pipe network, wherein at the same time, severity of defects is visually displayed by using colors, specifically, red indicates a severe defect, green indicates no defects, and yellow indicates a minor defect.
